(19) United States
(12) Patent Application Publication
(10) Pub. No.: US 2020/0176973 A1
(43) Pub. Date: Jun. 4, 2020

(54) DC OVERVOLTAGE PROTECTION FOR AN ENERGY STORAGE SYSTEM

(71) Applicant: SIEMENS AKTIENGESELLSCHAFT, München (DE)

(72) Inventors: Peter ECKERT, Erlangen (DE); Johannes REINSCHKE, Nuernberg (DE); Daniel LANGBEIN, Röttenbach (DE)

(73) Assignee: Siemens Aktiengesellschaft, München (DE)

(21) Appl. No.: 16/335,806

(22) PCT Filed: Sep. 5, 2017
(86) PCT No.: PCT/EP2017/072149

§ 371 Date: Mar. 22, 2019

(30) Foreign Application Priority Data
Sep. 22, 2016 (DE) 10 2016 218 219.6

(51) Int. Cl. H02H 3/20; H02H 7/125; H01H 9/54

(52) U.S. Cl. CPC H02H 3/202; H02H 1/04; H01H 9/542; H02H 7/1252

(57) ABSTRACT

A DC overvoltage protection device for an energy storage system, an energy storage system having such a DC overvoltage protection device, a method for operating a DC overvoltage protection device for an energy storage system and a method for operating an energy storage system having a DC overvoltage protection device. The DC overvoltage protection device includes at least one solid-state relay. The solid-state relay interrupts an auxiliary voltage circuit of the AC switch.

The invention relates to a DC overvoltage protection apparatus for an energy storage system, to an energy storage system having such a DC overvoltage protection apparatus, to a method for operating a DC overvoltage protection apparatus for an energy storage system and to a method for operating an energy storage system with a DC overvoltage protection apparatus.

Electrical energy storage systems having a plurality of converters (so-called AC-DC transducers) are known. One or more batteries are connected to each converter of such an energy storage system. If the converters are connected on the AC side to a common busbar and if there is no direct DC-side coupling, then in the case of the parallel connection of a plurality of converters on a common AC busbar, an undesired disconnection of the battery or batteries connected to the intermediate circuit and simultaneous pulse inhibition of the respectively associated converter, uncontrolled charging of the converter intermediate circuit can occur.

In such a case of uncontrolled charging of the converter intermediate circuit, the opening of an AC contactor associated with the converter or converters can be effected by means of an implemented software solution.

Since the software-based opening of the AC contactor does not always take place in a timely manner, the object of the invention consists in providing a reliable and fast alternative for the software-implemented release of the opening of the AC contactor that is also cost-effective.

This object is achieved by way of the features of independent claim 1 and the claims dependent thereon.

In particular, the object is realized by the most direct possible electrical coupling of the DC voltage measurement system, and the associated generation of a fault signal in the case of a DC overvoltage in the driver of the power section, with the AC switch of the converter by means of a solid-state relay. This achieves a situation in which, in addition to the mechanical switch-off time of the AC switch, there are no further delays, in particular switching delays. In the following text, an AC switch is to be understood to mean an AC contactor or AC circuit breaker. The solid-state relay is also known as a semiconductor relay.

In the case of an electrical energy storage system according to the invention, battery stores and stores based on ultracaps or supercaps, or supercapacitors, are preferred.

In an exemplary embodiment of a DC overvoltage protection apparatus for an energy storage system having at least one electrical energy storage device, a plurality of converters, in particular bidirectional AC-DC transducers, at least one AC switch, preferably an AC switch for each converter, having an auxiliary voltage circuit having an auxiliary voltage supply or a control voltage circuit, and at least one AC busbar, the DC overvoltage protection is implemented as follows. The converters of the plurality of converters each have a power section having a DC voltage measurement system and an interface, in particular a driver interface, having at least one output for a digital fault signal, wherein the DC overvoltage protection apparatus has at least one solid-state relay, the interface, in particular the driver interface, is connected or can be connected to the DC voltage measurement system in such a way that, in the event of an overvoltage at the DC voltage measurement system, a fault signal is transmitted from the interface, in particular the driver interface, to the at least one output for a digital fault signal, and the solid-state relay is connected or can be connected to the at least one output for a digital fault signal in such a way that the fault signal can be used or is used as an input signal for the solid-state relay, and the main contacts of the solid-state relay are connected or can be connected in series with the auxiliary voltage circuit or the control voltage circuit of the AC switch in the auxiliary voltage circuit or control voltage circuit of the AC switch in such a way that either opening of the solid-state relay interrupts the auxiliary voltage circuit of the AC switch or the auxiliary voltage circuit of the AC switch can be interrupted and thus switching of the AC switch to an interrupted switching state of the AC switch is effected or can be effected thereby, or a change in the switching state of the solid-state relay effects or can effect a switch-off signal in the control voltage circuit of the AC switch, and thus switching of the AC switch to an interrupted switching state of the AC switch is effected or can be effected thereby. The auxiliary voltage supply of the AC switch or AC contactor preferably keeps the AC switch or AC contactor closed as long as the auxiliary voltage circuit is not interrupted or the auxiliary voltage supply is disconnected. A control voltage in the control circuit of the AC switch or AC circuit breaker effects a change in the switching state.

In a preferred variant, the solid-state relay is secured to the power section of the converter or of the converter stack.

It is furthermore preferred that the solid-state relay has to withstand the inrush current of the AC switch without damage or without damage that adversely affects the switching capability. That is to say it is necessary to use a solid-state relay that can tolerate the full inrush current of the AC switch.

It is also preferred that, in the event of an overvoltage at the DC voltage measurement system at the at least one output for a digital fault signal, the fault signal changes over from a “high” state to a “low” state and thus opening of the solid-state relay is effected or can be effected. As an alternative, in the event of an overvoltage at the DC voltage measurement system at the at least one output for a digital fault signal, the fault signal can change over from a “low” state to a “high” state and thus opening of the solid-state relay is effected or can be effected thereby.

It is also preferred that, in a first operating state of the DC overvoltage protection apparatus in which the DC voltage measurement system does not produce an overvoltage, owing to the “high” state at the at least one output for a digital fault signal, which output is connected or can be connected to the input of the solid-state relay, the solid-state relay is kept in the closed state and the transition at the at least one output for a digital fault signal, which output is connected or can be connected to the input of the solid-state relay, in the “low” state effects a second operating state in which the solid-state relay is open, or

in a first operating state of the DC overvoltage protection apparatus in which the DC voltage measurement system does not produce an overvoltage, owing to the “low” state at the at least one output for a digital fault signal, which output is connected or can be connected to the input of the solid-state relay, the solid-state relay is kept in a closed state and the transition at the at least one output for a digital fault signal, which output is connected or can be connected to the input of the solid-state relay, in the “high” state effects a second operating state in which the solid-state relay is open.

It is furthermore preferred that the solid-state relay has a reaction time of less than or equal to 1 ms, preferably of less than 1 ms.

It is also preferred that the at least one AC switch has an opening time of less than 60 ms and preferably of less than 50 ms.

It is also preferred that the solid-state relay has an optocoupler.

It is furthermore preferred that the auxiliary voltage circuit or the control voltage circuit is designed as an AC auxiliary voltage circuit, at preferably 12 V, 48 V, 110 V or 230 V AC, or as a DC auxiliary voltage circuit, at preferably 12 V, 15 V, 24 V, 110 V or 220 V.

Also preferred is an energy storage system having at least one electrical energy storage device, a plurality of converters, in particular bidirectional AC-DC transducers, wherein the converters of the plurality of converters each have a power section having a DC voltage measurement system and an interface, in particular a driver interface, having at least one output for a digital fault signal, at least one AC switch having an auxiliary voltage circuit having an auxiliary voltage supply or a control circuit, at least one AC busbar, and a DC overvoltage protection apparatus as described in one or more preceding embodiments.

Also preferred is a method for operating a DC overvoltage protection apparatus for an energy storage system as per one of the preceding embodiments, wherein a fault signal from the at least one output for a digital fault signal at the DC voltage measurement system is used as an input signal of the solid-state relay, and wherein, in the event of an overvoltage at the DC overvoltage measurement system, the fault signal effects or can effect either opening of the auxiliary voltage circuit of the AC switch and hence switching of the AC switch to an interrupted switching state of the AC switch or a change in the switching state of the solid-state relay effects or can effect a switch-off signal in the control voltage circuit of the AC switch, and thus switching of the AC switch to an interrupted switching state of the AC switch is effected or can be effected thereby.

Furthermore preferred is the method for operating an energy storage system with a DC overvoltage protection apparatus as per the preceding embodiments, wherein a fault signal from the at least one output for a digital fault signal at the DC voltage measurement system is used as an input signal of the solid-state relay, and wherein, in the event of an overvoltage at the DC voltage measurement system, the fault signal effects or can effects either opening of the auxiliary voltage circuit of the AC switch and hence switching of the AC switch to an interrupted switching state of the AC switch or a change in the switching state of the solid-state relay effects or can effect a switch-off signal in the control voltage circuit of the AC switch, and thus switching of the AC switch to an interrupted switching state of the AC switch is effected or can be effected thereby.

In the following text, the subject matter of the invention is explained in more detail on the basis of individual illustrations and figures:

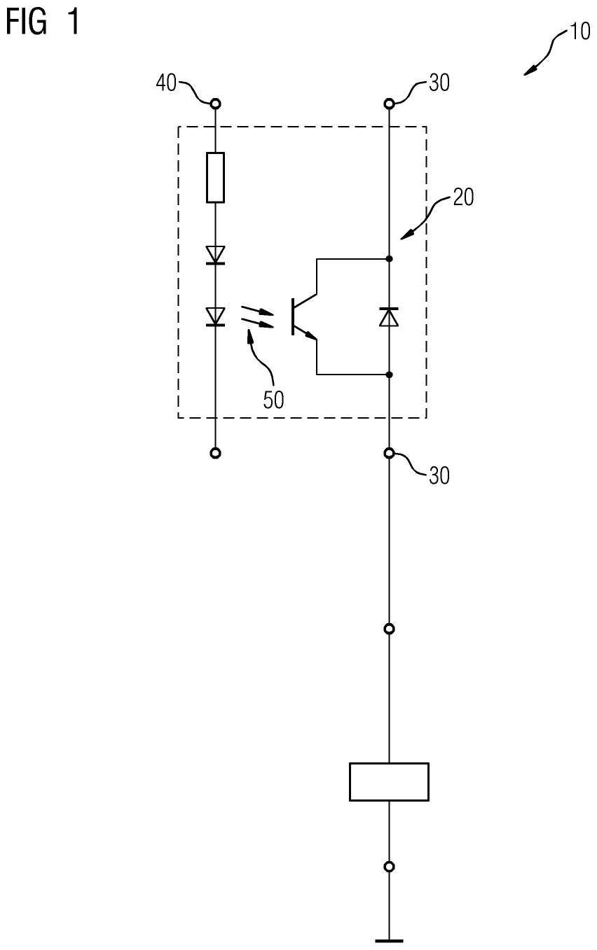

FIG. 1: shows an equivalent circuit diagram of the solid-state relay

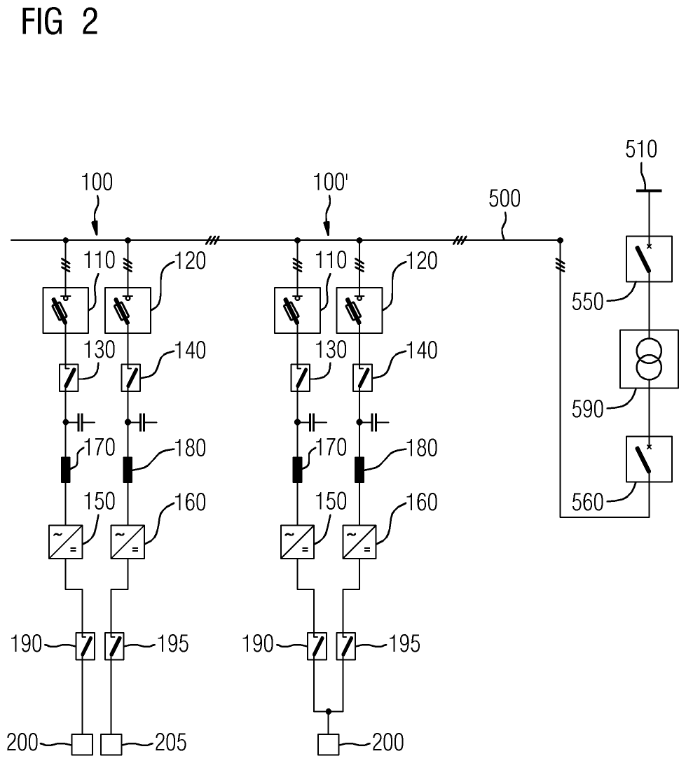

FIG. 2: shows two variants for energy storage systems having converters.

FIG. 1 shows an equivalent circuit diagram of a solid-state relay 20, as can be used in a DC overvoltage protection apparatus 10. According to the invention, the fault signal, which is transmitted from the interface, in particular the driver interface, to the at least one output for a digital fault signal, is used as an input signal 40 for the solid-state relay 20. The main contacts 30 of the solid-state relay 20 are connected in series with the auxiliary voltage supply of the AC switch in the auxiliary voltage circuit of the AC switch. In the event of an overvoltage at the DC voltage measurement system, the fault signal or the change in the fault signal causes the solid-state relay to interrupt the auxiliary voltage circuit of the AC switch, and hence the auxiliary voltage supply, and thus effects opening of the AC switch. Owing to this direct use of the fault signal as an input signal of the solid-state relay, a direct electrical coupling of the DC overvoltage measurement system with the AC switch is achieved. As a result, in this implementation, there are no considerable switching delays in addition to the reaction time of the AC switch. In the variant shown, the solid-state relay operates by way of an optocoupler 50. In this case, the voltage of the input signal is preferably 15 V and the voltage of the auxiliary voltage supply of the AC switch is preferably 24 V.

FIG. 2 shows two examples for variants 100, 100′ of how battery stores 200, 205 and converters 150, 160 can be connected to a network terminal connection 510 by means of a common AC busbar 500. The first and second variant 100 and 100′ in this case each have AC switches 130, 140.

The AC busbar 500 is preferably connected to the network terminal connection via a transformer 590, wherein a respective switch, particularly preferably a circuit breaker 550, 560, is preferably present behind and in front of the transformer.

In the first variant 100, by way of example two strands branch off from the AC busbar 500, said strands each being led via a load interrupter 110, 120, an AC switch/AC contactor 130, 140 and an LC filter circuit 170, 180 to a converter 150, 160; the converters 150, 160 are connected to a respective battery store 200, 205 via DC switches 190, 195. The two strands of the first variant 100 are not coupled, or only capacitively, on the DC side, in particular capacitively coupled via the battery stores. Even if only two strands are shown in the first variant 100, said variant is the basic construction, with the result that more than two strands are also possible.

In the second variant 100′, by way of example two strands branch off from the AC busbar 500, said strands each being led via a load interrupter 110, 120, an AC switch/AC contactor 130, 140 and an LC filter circuit 170, 180 to a converter 150, 160; the converters 150, 160 are connected to a battery store 200 via DC switches 190, 195. The two strands of the second variant 100′ are coupled on the DC side, in particular capacitively coupled via the battery stores. Even if only two strands are shown in the second variant 100′, said variant is the basic construction, with the result that more than two strands are also possible.

The combination shown here of the variants 100, 100′ is also possible. The two variants 100, 100′ shown can also be combined with other superstructures for connecting the electrical energy storage devices.

### LIST OF REFERENCE SIGNS

10 DC overvoltage protection
20 Solid-state relay
30 Auxiliary voltage circuit of an AC switch
40 Input signal of the solid-state relay
50 Optocoupler of the solid-state relay
100 First variant of an energy storage device with converter
110, 120 Load interrupter with fusible link
130, 140 AC switch/AC contactor
150, 160 Converter
170, 180 LC filter circuit
190, 195 DC switch
200, 205 Electrical energy storage device
500 AC busbar
510 Network connection terminal
550 AC switch/AC contactor
590 Transformer

1-10. (canceled)

11. A DC overvoltage protection apparatus for an energy storage system, the apparatus comprising:
at least one electrical energy storage device;
at least one AC switch having an auxiliary voltage circuit with an auxiliary voltage supply or a control voltage circuit;
at least one AC busbar;
a plurality of converters each having a power section with a DC voltage measurement system and an interface with at least one output for a digital fault signal;
said interface being configured for connection to said DC voltage measurement system in such a way that, in the event of an overvoltage at said DC voltage measurement system, a fault signal is transmitted from said interface to said at least one output for the digital fault signal; and
at least one solid-state relay configured for connection to said at least one output for the digital fault signal, with the fault signal becoming an input signal for said solid-state relay; and
said solid-state relay having main contacts for connection in series with said auxiliary voltage circuit or said control voltage circuit of said at least one AC switch, wherein:
opening said solid-state relay interrupts said auxiliary voltage circuit of said AC switch or enables said auxiliary voltage circuit of said AC switch to be interrupted and a switching of said AC switch to an interrupted switching state of said AC switch is effected or can be effected thereby; or
a change in a switching state of said solid-state relay effects a switch-off signal in said control voltage circuit of said AC switch, and thus effects a switching of said AC switch to an interrupted switching state of said AC switch.

12. The DC overvoltage protection apparatus according to claim 11, wherein:
said converters are bidirectional AC-DC converters;
each of said converters has at least one AC switch associated therewith;
said interface of said converters is a driver interface.

13. The DC overvoltage protection apparatus according to claim 11, wherein:
in the event of an overvoltage at said DC voltage measurement system at said at least one output for the digital fault signal, the fault signal changes over from a “high” state to a “low” state and thus opens said solid-state relay; or
in the event of an overvoltage at the DC voltage measurement system at said at least one output for the digital fault signal, the fault signal changes over from a “low” state to a “high” state and thus opens said solid-state relay.

14. The DC overvoltage protection apparatus according to claim 13, wherein:
in a first operating state of the DC overvoltage protection apparatus in which said DC voltage measurement system does not indicate an overvoltage, owing to the “high” state at said at least one output for the digital fault signal, which output is connected or can be connected to said input of said solid-state relay, said solid-state relay remains in a closed state and a transition at said at least one output for the digital fault signal to the “low” state effects a second operating state in which said solid-state relay is open; or
in the first operating state of the DC overvoltage protection apparatus in which the DC voltage measurement system does not indicate an overvoltage, owing to the “low” state at said at least one output for the digital fault signal, which output is connected or can be connected to said input of said solid-state relay, said solid-state relay remains in a closed state and a transition at said at least one output for the digital fault signal to the “high” state effects the second operating state in which said solid-state relay is open.

15. The DC overvoltage protection apparatus according to claim 11, wherein said solid-state relay has a reaction time of less than or equal to 1 ms.

16. The DC overvoltage protection apparatus according to claim 11, wherein said solid-state relay has a reaction time of less than 1 ms.

17. The DC overvoltage protection apparatus according to claim 11, wherein said at least one AC switch has an opening time of less than 60 ms.

18. The DC overvoltage protection apparatus according to claim 17, wherein said at least one AC switch has an opening time of less than 50 ms.

19. The DC overvoltage protection apparatus according to claim 11, wherein said solid-state relay has an optocoupler.

20. The DC overvoltage protection apparatus according to claim 11, wherein said auxiliary voltage circuit or said control voltage circuit is an AC auxiliary voltage circuit configured for 12 V, 48 V, 110 V or 230 V AC.

21. The DC overvoltage protection apparatus according to claim 11, wherein said auxiliary voltage circuit or said control voltage circuit is a DC auxiliary voltage circuit configured for 12 V, 15 V, 24 V, 110 V or 220 V.

22. An energy storage system comprising:
at least one electrical energy storage device;
a plurality of converters each having a power section with a DC voltage measurement system and an interface having an output for a digital fault signal;
at least one AC switch having an auxiliary voltage circuit and an auxiliary voltage supply;
at least one AC busbar; and
a DC overvoltage protection apparatus according to claim 11.

23. The energy storage system according to claim 22, wherein:
said converters are AC-DC converters; and
said interface of said converters is a driver interface.

24. A method of operating a DC overvoltage protection apparatus for an energy storage system, the method comprising:
providing a DC overvoltage protection apparatus according to claim 11;
using an output signal at the fault signal output of the DC voltage measurement system as an input signal of the solid-state relay, and, in the event of an overvoltage, effecting with the fault signal an opening of the auxiliary voltage circuit of the AC switch and hence switching of the AC switch to an interrupted switching state.

25. A method for operating an energy storage system, the method comprising:
providing an energy storage system according to claim 22;
using a fault signal from the at least one output for a digital fault signal at the DC voltage measurement system as an input signal of the solid-state relay, and, in the event of an overvoltage, causing the fault signal to open the auxiliary voltage circuit of the AC switch and switching the AC switch to an interrupted switching state.
